(19) United States
(12) Patent Application Publication
(10) Pub. No.: US 2018/0363620 A1
(43) Pub. Date: Dec. 20, 2018

(54) Wave Power Device

(71) Applicant: Howard Scoggins, Seabrook, TX (US)

(72) Inventor: Howard Scoggins, Seabrook, TX (US)

(21) Appl. No.: 15/624,220

(22) Filed: Jun. 15, 2017

(51) Int. Cl. F03B 13/16

(52) U.S. Cl. CPC F03B 13/16; F05B 2260/964; F05B 2220/706

(57) ABSTRACT

A power developing apparatus adapted to derive power from waves is disclosed. The apparatus includes a float, a rack gear coupled to the float, a pinion gear driven by the rack gear, and a power utilizing device rotated from the pinion gear. The power utilizing device may be a generator or a pump. The generator may have an excitation field controlled to assure unidirectional motion. A unidirectional clutch may be installed in series with the pinion gear. A weight may depend from the rack gear. A damper such as a coil spring may be located between the weight and the rack gear.

### FIELD OF THE DISCLOSURE

The present disclosure relates to capture of energy from the ocean, for powering appliances.

### BACKGROUND

It has long been the goal of the human race to exploit natural energy, such as periodic movements of ocean water. Many schemes have been proposed for capturing rising and falling ocean surfaces, and connecting power derived therefrom to drive power utilizing devices. Despite the many devices of the prior art, there remains a need for an uncomplicated device to capture energy from rising and falling ocean surfaces, and to apply power to power utilizing devices.

### SUMMARY

The disclosed concepts address the above stated situation by providing a power developing apparatus powered by rising and falling water levels of a body of water.

The apparatus includes a float, a rack gear coupled to the float, a pinion gear driven by the rack gear, and a power utilizing device rotated from the pinion gear. The power utilizing device may be a generator or a pump. The generator may have an excitation field controlled to assure unidirectional motion. A unidirectional clutch may be installed in series with the pinion gear. A weight may depend from the rack gear. A damper such as a coil spring may be located between the weight and the rack gear.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a diagrammatic environmental view of a power developing apparatus, according to at least one aspect of the disclosure;

FIG. 2 is a diagrammatic detail view of one embodiment of a component shown at the upper left of FIG. 1, according to at least one aspect of the disclosure; and

FIG. 3 is a diagrammatic detail view of another embodiment of the component shown in the upper left of FIG. 1, according to at least one aspect of the disclosure.

### DETAILED DESCRIPTION

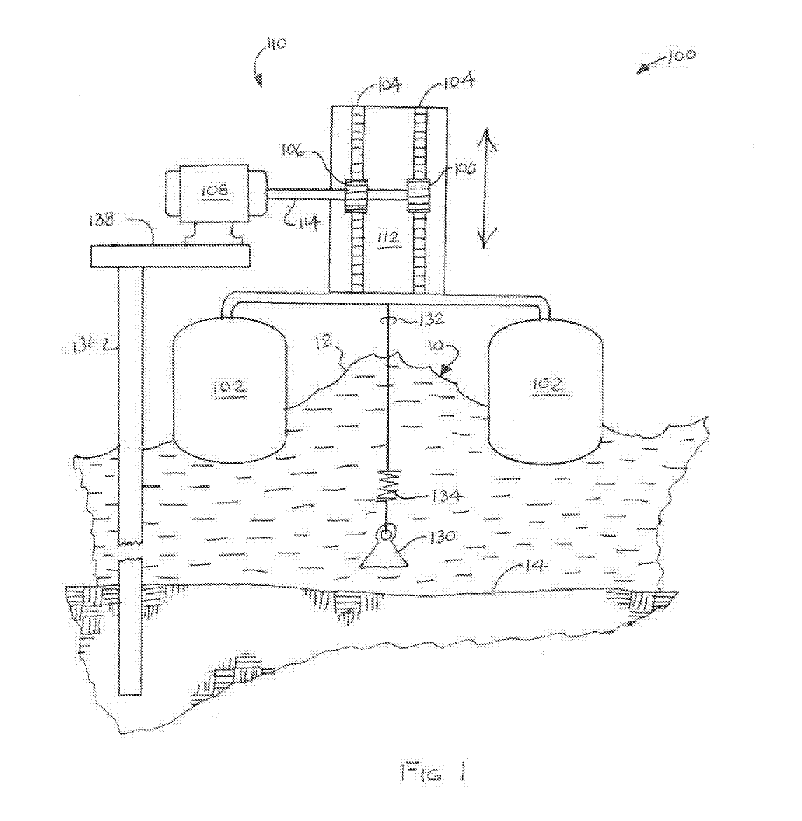

Referring first to FIG. 1, according to at least one aspect of the disclosure, there is shown a power developing apparatus 100 for deriving power from a rising and falling water surface 10. Power developing apparatus 100 comprises a float 102 arranged to rise and fall with rising and falling of rising and falling water surface 10, a rack gear 104 coupled to float 102, rack gear 104 enabled to rise and fall as float 102 rises and falls, a pinion gear 106 in drive engagement with rack gear 104. Pinion gear 106 is arranged to rotate responsive to rising and falling of float 102 and rack gear 104. Power developing apparatus 100 further comprises a power utilizing device 108 rotatably coupled to pinion gear 106, and a rotation direction controller 110 (further described hereinafter) operably connected to one of pinion gear 106 and power utilizing device 108 to cause power to be applied unidrectionally to power utilizing device 108. In the example of FIG. 1, there are two rack gears 104 fixed in common to a plate 112, two pinion gears 106, and two floats 102. The actual number of rack gears 104, pinion gears 106, and floats 102 may be varied as desired.

As floats 102 rise and fall with water surface 10 responsive to waves 12, plate 112 and therefore rack gears 104 rise and fall in tandem. Pinion gears 106 rotate responsively to rack gears 104 rising and falling. Pinion gears 106 provide a controlled input to rotate power utilizing device 108 via a shaft 114. The input is controlled in that it is rotary, but rather changing direction as pinion gears 106 change direction, the input is unidirectional relative to internal components of power utilizing device 108.

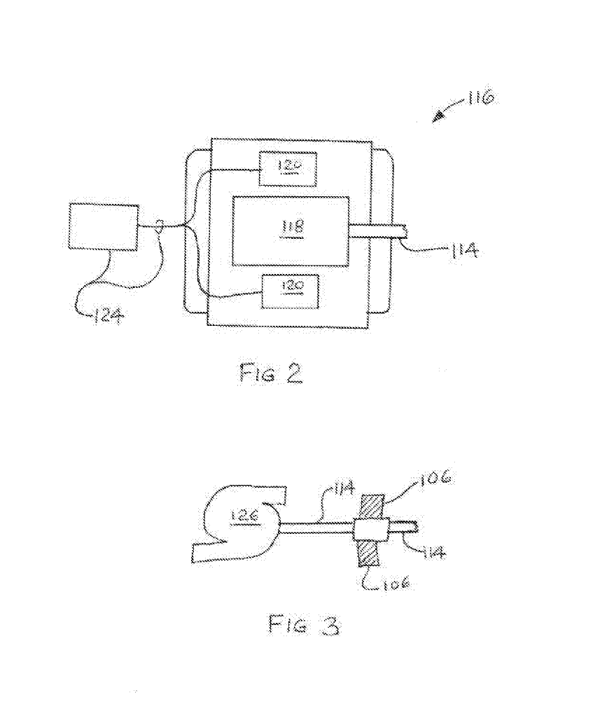

In the example of FIG. 1, but also referring to FIG. 2, power utilizing device 108 may comprise an electrical generator 116 including a rotatable armature 118 and field excitation coils 120. In this example, rotation direction controller 110 (FIG. 1) comprises circuitry 124 limiting field excitation of generator 116 such that field excitation is applied in only one direction of rotation of armature 118.

Referring to FIGS. 1 and 3, power utilizing device 108 may comprise a pump 126, such as a centrifugal pump, turbine pump, or piston pump (these variants are not separately shown). In the example of FIG. 3, rotation direction controller 110 may comprise a unidirectional clutch 128 between pinion gear 106 and power utilizing device 108 (i.e., pump 126).

Still referring to FIG. 1, power developing apparatus 100 may further comprise a weight 130 depending from rack gear(s) 104 via a cable 132 fixed to plate 112. Weight 130 assures downward return of plate 112 after the latter has risen responsive to a wave 12 acting on float(s) 102. A motion damper 134 between rack gear(s) 104 and weight 130. Motion damper 134 may comprise a coil spring as illustrated in FIG. 1.

It should be noted at this point that orientational terms such as depending refer to the subject drawing as viewed by an observer. The drawing figures depict their subject matter in orientations of normal use, which could obviously change with circumstances. Therefore, orientational terms must be understood to provide semantic basis for purposes of description only, and do not imply that their subject matter can be used only in one position.

If desired, shaft 114 may be used as a power output device, shaft 114 terminating in a gear, splines, or incorporating a keyway or other structure (none of these options is shown) to enable rotational driving of an appliance to be powered from shaft 114.

Power developing apparatus 100 may be secured in place relative to water surface 10 by a support such as a stanchion 136 suitably anchored in place. For example, stanchion 136 may be driven into a bed 14 of the body of water being exploited for power. Alternatively, stanchion 136 could comprise or be replaced by a weighted base (not shown) resting on bed 14.

As the explanation of the novel power developing apparatus 100 is theoretical, it will be understood that the components described herein may be protected within a suitable water resistant housing (not shown) fixed to a platfrom 138 supporting power utilizing device 108. Power developing apparatus 100 will be understood to include structure for supporting and guiding moving components described herein, which structure is omitted for brevity. Also, power utilizing device 108 may comprise output components such as electrical conductors (not shown) where power utilizing device 108 comprises generator 116, or fluid conduits (not shown) where power utilizing device 108 comprises pump 126.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

I claim:

1. A power developing apparatus for deriving power from a rising and falling water surface, the power developing apparatus comprising:
a float arranged to rise and fall with rising and falling of the rising and falling water surface;
a rack gear coupled to the float, the rack gear enabled to rise and fall as the float rises and falls;
a pinion gear in drive engagement with the rack gear, the pinion gear arranged to rotate responsive to rising and falling of the float and the rack gear;
a power utilizing device rotatably coupled to the pinion gear; and
a rotation direction controller operably connected to one of the pinion gear and the power utilizing device to cause power to be applied unidrectionally to the power utilizing device.

2. The power developing apparatus of claim 1, wherein the power utilizing device comprises an electrical generator including a rotatable armature.

3. The power developing apparatus of claim 2, wherein the rotation direction controller comprises circuitry limiting field excitation of the generator such that field excitation is applied in only one direction of rotation of the armature.

4. The power developing apparatus of claim 1, wherein the power utilizing device comprises a pump.

5. The power developing apparatus of claim 1, wherein the rotation direction controller comprises a unidirectional clutch between the pinion gear and the power utilizing device.

6. The power developing apparatus of claim 1, further comprising a weight depending from the rack gear.

7. The power developing apparatus of claim 6, further comprising a motion damper between the rack gear and the weight.

8. The power developing apparatus of claim 7, wherein the motion damper comprises a coil spring.

9. The power developing apparatus of claim 1, further comprising a support engaging a bed of a body of water being exploited for power, the support for securing power developing the power developing apparatus in place relative to the water surface.
